(19) United States
(12) Patent Application Publication
(10) Pub. No.: US 2017/0255046 A1
(43) Pub. Date: Sep. 7, 2017

(54) DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Huishun CHEN, Beijing (CN); Kaixuan WANG, Beijing (CN); Wei LI, Beijing (CN); Hongliang YUAN, Beijing (CN); Xiaojuan WU, Beijing (CN); Li MA, Beijing (CN); Yang YOU, Beijing (CN); Xiaoqing PENG, Beijing (CN); Zijing ZHANG, Beijing (CN); Yao BI, Beijing (CN); Dong LIANG, Beijing (CN); Qi ZHENG, Beijing (CN)

(21) Appl. No.: 15/213,743

(22) Filed: Jul. 19, 2016

(30) Foreign Application Priority Data
Mar. 3, 2016 (CN) 201610121690.5

(51) Int. Cl. G02F 1/1339; G02F 1/1335; G02F 1/133

(52) U.S. Cl. CPC G02F 1/13394; G02F 1/13306; G02F 1/133514; G02F 2001/13398

(57) ABSTRACT

Disclosed is a display device, comprising an array substrate and a color filter substrate which are opposite to each other, and wall-spacers, the wall-spacers being arranged between the array substrate and the color filter substrate and being in an area surrounding a display area formed by the array substrate and the color filter substrate. The wall-spacers are made of an electrostriction material, and a vertical distance between the array substrate and the color filter substrate in the area surrounding the display area is adjusted by applying different driving voltages to the wall-spacers.

### CROSS-REFERENCES TO RELATED APPLICATIONS

The present application claims priority to Chinese Patent Application No. 201610121690.5 filed on Mar. 3, 2016, the disclosure of which is hereby incorporated by reference in its entirety.

### FIELD

The present invention relates to the field of display technology, and particularly, to a display device.

### BACKGROUND

Liquid Crystal Displays (LCDs) have been recognized as excellence in the fields of digital display and large-size display due to their advantages of lighter, thinner, high quality display and the like. In manufacturing process of the LCD, layout of the display area of a LCD panel and layout of the peripheral area of the LCD panel are different. For example, a in-cell height (i.e., a vertical distance between an array substrate and a color filter substrate) in the peripheral area of a LCD panel is generally different from a in-cell height in the display area of the LCD panel. Accordingly, a problem occurs, in which a peripheral yellow or white gap appears, so that the yield is decreased.

To solve the above problem, height of silicon ball (SI Ball) in the sealant is adjusted in the prior process to improve the consistency of cell heights in the peripheral area and the display area of the LCD panel. However, this method is limited by process fluctuations, and is hardly to adjust the cell height in the peripheral area in a continuous manner, so that the problem that a peripheral yellow or white gap appears cannot be effectively solved.

### SUMMARY

In view of one of the technical problems existing in the prior art, the present invention provides a display device, in which the cell height in the peripheral area of the LCD panel can be adjusted in a continuous manner, so that the problem that a peripheral yellow or white gap appears can be effectively solved.

An embodiment of the present invention provides a display device, comprising an array substrate and a color filter substrate which are opposite to each other, and wall-spacers, the wall-spacers being arranged between the array substrate and the color filter substrate and being in an area surrounding a display area formed by the array substrate and the color filter substrate; each wall-spacer is made of an electrostriction material, and a vertical distance between the array substrate and the color filter substrate in the area surrounding the display area is adjusted by applying different driving voltages to the wall-spacers.

Optionally, each of the wall-spacers comprises a plurality of pillars which are vertically arranged, and the plurality of pillars are distributed and spaced in the area surrounding the display area; a top end and a bottom end of each pillar contact the color filter substrate and the array substrate, respectively.

Optionally, the top end and the bottom end of each pillar contact a lower surface of the color filter substrate that faces the array substrate and an upper surface of the array substrate that faces the color filter substrate, respectively.

Optionally, a lower surface of the color filter substrate that faces the array substrate comprises recesses, and the top end of each pillar contacts a bottom of a corresponding recess.

Optionally, an upper surface of the array substrate that faces the color filter substrate comprises recesses, and the bottom end of each pillar contacts a bottom of a corresponding recess.

Optionally, a lower surface of the color filter substrate that faces the array substrate and an upper surface of the array substrate that faces the color filter substrate comprise recesses, and the top end and the bottom end of each pillar contact bottoms of corresponding recesses.

Optionally, cross section of the pillar is of a shape comprising a circular shape, an elliptical shape, a triangular shape, a polygonal shape or an irregular shape.

Optionally, the display device further comprises a driving circuit for applying driving voltages to the pillars.

Optionally, the driving circuit comprises a first circuit and a second circuit, wherein the first circuit is on the color filter substrate and is electrically connected with the top end of each pillar; the second circuit is on the array substrate and is electrically connected with the bottom end of each pillar; and the first circuit and the second circuit are used for applying driving voltages to the top end and the bottom end of each pillar, respectively.

Optionally, the first circuit comprises four first branches, and the second circuit comprises four second branches, wherein the four first branches correspond to four sides of the color filter substrate in a one-to-one correspondence; the four second branches correspond to four sides of the array substrate in a one-to-one correspondence; and the first branch and the second branch corresponding to a same side are used for applying driving voltages to the top end and the bottom end of each pillar on the same side.

Optionally, the display device further comprises a control unit, which is used for controlling the driving circuit to apply different driving voltages to each pillar in a timing control manner.

Optionally, the electrostriction material comprises a leaded material or a paraelectric crystal.

The present invention has the following beneficial effects.

In the display device provided by the present invention, the wall-spacers are provided between the array substrate and the color filter substrate in an area surrounding the display area formed by the array substrate and the color filter substrate. Since the wall-spacers are made of an electrostriction material, a length of which can be varied with changes of the amplitude of the applied driving voltage, the vertical distance between the array substrate and the color substrate in the area surrounding the display area can be adjusted by applying different driving voltages to the wall-spacers, that is, the in-cell height in the area surrounding the display area is adjusted continuously, so that the problem that a peripheral yellow or white gap appears can be effectively solved.

### BRIEF DESCRIPTION OF THE FIGURES

FIG. 1 is a schematic diagram of a display device provided by the present invention;

FIG. 2 is a partial section view of a display device provided by a first embodiment of the present invention;

FIG. 3 is a structural diagram of a pillar used in the first embodiment of the present invention; and

FIG. 4 is a partial section view of a display device provided by a second embodiment of the present invention.

### DETAILED DESCRIPTION OF THE EMBODIMENTS

To make those of skilled in the art better understand the technical solutions of the present invention, the display device provided by the present invention will be described below in detail in conjunction with the accompanying drawings.

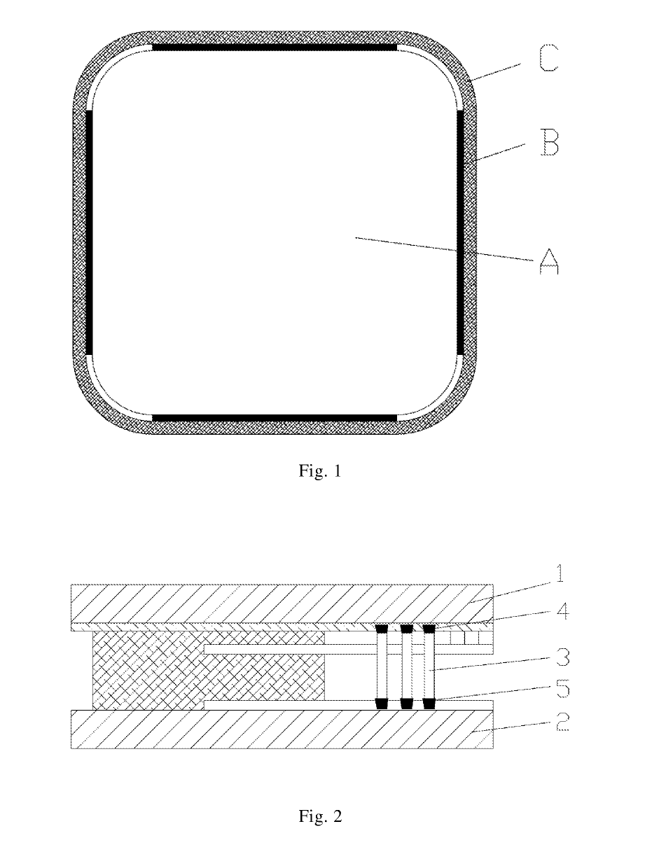

FIG. 1 is a schematic diagram of a display device provided by the present invention. FIG. 2 is a partial section view of a display device provided by a first embodiment of the present invention. Referring to FIG. 1 and FIG. 2, the display device comprises a color filter substrate 1 and an array substrate 2 which are opposite to each other, and a display area formed by the color filter substrate 1 and the array substrate 2 is area A, as shown in FIG. 1. Wall-spacers are provided between the array substrate 2 and the color filter substrate 1 in an area surrounding the display area (i.e., area A), and the wall-spacers are distributed in an area B, as shown in FIG. 1. A sealant is provided between the array substrate 2 and the color filter substrate 1 in an area surrounding the area (i.e., area B) where the wall-spacers are distributed, and the sealant is distributed in an area C, as shown in FIG. 1. From above it can be seen that, the area B is between the area A and the area C.

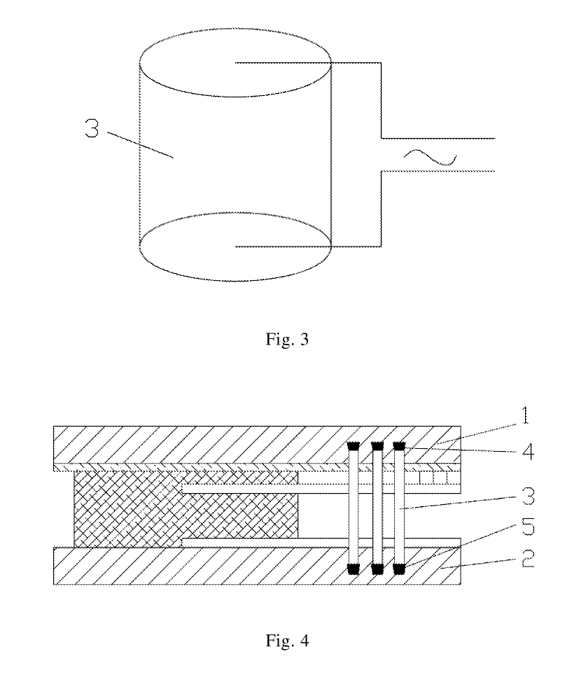

In the first embodiment of the present invention, the wall-spacer comprises a plurality of pillars 3 which are vertically arranged, and the plurality of pillars 3 are distributed and spaced in the area surrounding the display area, as shown in FIG. 2, only three pillars 3 are exemplarily illustrated. A top end and a bottom end of each pillar 3 contact the color filter substrate 1 and the array substrate 2, respectively. FIG. 3 is a structural diagram of the pillar 3 used in the first embodiment of the present invention. As shown in FIG. 3, cross section of the pillar 3 is of a circular shape, that is, the pillar 3 is a cylinder. Moreover, the pillar 3 is made of an electrostriction material, e.g., a leaded material such as lead magnesium niobate or a paraelectric crystal such as potassium tantalate niobate (KTN). A length of the electrostriction material in a driving voltage direction will vary with the changes of the amplitude of the applied driving voltage, which is expressed by the following equation:

ΔL=LME²,

where ΔL is length variation of the electrostriction material in the driving voltage direction; L is an initial length of the electrostriction material in the driving voltage direction; M is an electrostrictive coefficient (e.g., M=10⁻¹⁴ m²/V²); and E is intensity of an electric field induced by the driving voltage. From the equation it can be seen that, the deformation amount of the electrostriction material is merely related to the amplitude of the driving voltage, and is independent of the direction of the driving voltage. Thus, the driving voltage may be an alternating voltage. Moreover, the electrostriction material has the feature that its deformation amount can be large when only a small driving voltage is applied thereto. Therefore, by changing the amplitudes of the driving voltages applied to the top and bottom ends of each pillar 3, the each pillar 3 can generate various deformation amounts in its axis direction (i.e., its lengthwise direction), such that the vertical distances between the array substrate 2 and the color filter substrate 1 at positions where the pillars 3 are located can be adjusted, which in turn enables the in-cell height in the area surrounding the display area to be adjusted in a continuous manner, thereby effectively solving the problem that a peripheral yellow or white gap appears.

In the first embodiment of the present invention, the driving voltages are applied to the pillar 3 by a driving circuit. Specifically, the driving circuit comprises a first circuit 4 and a second circuit 5, wherein the first circuit 4 is on the color filter substrate 1 and is electrically connected with the top end of each pillar 3; the second circuit 5 is on the array substrate 2 and is electrically connected with the bottom end of each pillar 3; and the first circuit 4 and the second circuit 5 are used for applying driving voltages to the top end and the bottom end of each pillar 3, respectively. In other words, by the first circuit 4 and the second circuit 5, the top end and the bottom end of each pillar 3 are electrically connected to a positive terminal and a negative terminal of an alternating current power supply, respectively, and the pillars 3 are connected to each other in parallel.

Optionally, in order to separately apply driving voltages to the top ends and the bottom ends of the pillars 3, which are respectively located outside of four sides of the display area (the display area is generally of a rectangular shape and has four sides), the first circuit 4 further comprises four first branches and the second circuit 5 further comprises four second branches, wherein the four first branches correspond to four sides of the color filter substrate 1 in a one-to-one correspondence; the four second branches correspond to four sides of the array substrate 2 in a one-to-one correspondence; and the first branch and the second branch corresponding to a same side are used for applying driving voltages to the top end and the bottom end of each pillar 3 on the same side, so that the in-cell height in the surrounding area at a side of the display area can be independently controlled, thereby improving flexibility of the control.

Optionally, the display device further comprises a control unit (not shown in figures), which is used for controlling the driving circuit to apply different driving voltages to each pillar 3 in a timing control manner, so as to achieve an automatic control, such that the in-cell height in the area surrounding the display area can be continuously adjusted, which in turn effectively solves the problem that a peripheral yellow or white gap appears.

It should be noted that the cross section of the pillar 3 is of a circular shape in the first embodiment of the present invention, but the present invention is not limited thereto. In practical applications, the cross section of the pillar 3 may be of any other shape, such as an elliptical shape, a triangular shape, a polygonal shape or an irregular shape.

FIG. 4 is a partial section view of a display device provided by a second embodiment of the present invention. Referring to FIG. 4, the only difference between the display device in the second embodiment and that in the first embodiment lies in that the top end and the bottom end of the pillar 3 are connected with the color filter substrate 1 and the array substrate 2, respectively, in different manners.

Specifically, a lower surface of the color filter substrate 1 that faces the array substrate 2 and an upper surface of the array substrate 2 that faces the color filter substrate 1 comprises recesses, and the top end and the bottom end of each pillar 3 contact bottoms of corresponding recesses on the color filter substrate 1 and the array substrate 2, respectively. In such manner, the length of the pillar 3 can be larger, i.e., the initial length of the electrostriction material in the driving voltage direction can be larger, so that the deformation amount of the electrostriction material can be larger, and the in-cell height in the area surrounding the display area can be adjusted to a larger extent.

It should be noted that, in actual applications, the recesses may be merely provided on the lower surface of the color filter substrate or the upper surface of the array substrate in accordance with actual needs, and accordingly, the top end or the bottom end of each pillar contacts the bottom of the corresponding recess.

In general, in the display device provided by each embodiment of the present invention, the vertical distance between the array substrate and the color filter substrate in the area surrounding the display area can be adjusted by applying different voltages to the wall-spacers, i.e., the in-cell height in the area surrounding the display area can be continuously adjusted, thereby effectively solving the problem that a peripheral yellow or white gap appears.

It could be understood that the above embodiments are merely exemplary embodiments adopted for describing the principle of the present invention, but the present invention is not limited thereto. Various variations and improvements may be made for those with ordinary skill in the art without departing from the spirit and essence of the present invention, and these variations and improvements shall also fall within the protection scope of the present invention.

What is claimed is:

1. A display device, comprising an array substrate and a color filter substrate which are opposite to each other, and wall-spacers, the wall-spacers being arranged between the array substrate and the color filter substrate and being in an area surrounding a display area formed by the array substrate and the color filter substrate;
each of the wall-spacers is made of an electrostriction material, and a vertical distance between the array substrate and the color filter substrate in the area surrounding the display area is adjusted by applying different driving voltages to the wall-spacers.

2. The display device according to claim 1, wherein each wall-spacer comprises a plurality of pillars which are vertically arranged, and the plurality of pillars are distributed and spaced in the area surrounding the display area; and
a top end and a bottom end of each pillar contact the color filter substrate and the array substrate, respectively.

3. The display device according to claim 2, wherein the top end and the bottom end of each pillar contact a lower surface of the color filter substrate that faces the array substrate and an upper surface of the array substrate that faces the color filter substrate, respectively.

4. The display device according to claim 2, wherein a lower surface of the color filter substrate that faces the array substrate comprises recesses, and the top end of each pillar contacts a bottom of a corresponding recess.

5. The display device according to claim 2, wherein an upper surface of the array substrate that faces the color filter substrate comprises recesses, and the bottom end of each pillar contacts a bottom of a corresponding recess.

6. The display device according to claim 2, wherein a lower surface of the color filter substrate that faces the array substrate and an upper surface of the array substrate that faces the color filter substrate comprise recesses, and the top end and the bottom end of each pillar contact bottoms of corresponding recesses.

7. The display device according to claim 2, wherein cross section of the pillar is of a shape comprising a circular shape, an elliptical shape, a triangular shape, a polygonal shape or an irregular shape.

8. The display device according to claim 2, wherein the display device further comprises a driving circuit for applying driving voltages to the pillars.

9. The display device according to claim 8, wherein the driving circuit comprises a first circuit and a second circuit, and wherein
the first circuit is on the color filter substrate and is electrically connected with the top end of each pillar;
the second circuit is on the array substrate and is electrically connected with the bottom end of each pillar; and
the first circuit and the second circuit are used for applying driving voltages to the top end and the bottom end of each pillar, respectively.

10. The display device according to claim 9, wherein the first circuit comprises four first branches, and the second circuit comprises four second branches, and wherein
the four first branches correspond to four sides of the color filter substrate in a one-to-one correspondence;
the four second branches correspond to four sides of the array substrate in a one-to-one correspondence; and
the first branch and the second branch corresponding to a same side are used for applying driving voltages to the top end and the bottom end of each pillar on the same side.

11. The display device according to claim 8, wherein the display device further comprises a control unit, which is used for controlling the driving circuit to apply different driving voltages to each pillar in a timing control manner.

12. The display device according to claim 1, wherein the electrostriction material comprises a leaded material or a paraelectric crystal.
